(19) United States
(12) Patent Application Publication
(10) Pub. No.: US 2011/0194317 A1
(43) Pub. Date: Aug. 11, 2011

(54) STACKED FLYBACK CONVERTER WITH INDEPENDENT CURRENT LOOP CONTROL

(75) Inventors: Donald J. Truettner, Waukesha, WI (US); Kalyan P. Gokhale, New Berlin, WI (US)

(73) Assignee: ABB INC., Norwalk, CT (US)

(21) Appl. No.: 13/059,872

(22) PCT Filed: Aug. 20, 2009
(86) PCT No.: PCT/US2009/054430

§ 371 Date: Apr. 29, 2011

Related U.S. Application Data
(60) Provisional application No. 61/091,038, filed on Aug. 22, 2008.

(51) Int. Cl. H02M 3/335

(52) U.S. Cl. 363/21.18

(57) ABSTRACT

A voltage converter includes a transformer with a pair of primary coils and a secondary coil. The converter has a DC input and a capacitor bank, having a pair of capacitors, is connected across the DC input. A switch is associated with each primary coil. A gate drive feedback module outputs a pulse width modulated signal to drive either the first or second primary coil. A gate drive switch has as an input the pulse width modulated signal and outputs to the first second switch. A pulse steering logic module determines which of the first or second capacitors has a higher voltage and controls the gate drive switch to direct the pulse width modulated signal in response thereto.

### BACKGROUND

Microprocessor control of today's electronic equipment requires efficient means of supplying power. Most line operated equipment utilizes some form of switching power supply to deliver control power to load circuits. Generally, a switching power supply rapidly switches a power transistor between a saturation state (full on) and cutoff (completely off) state, with a variable duty cycle whose average is the desired output voltage. In the North American market, typical three phase industrial power can range from about 208 VAC to about 575 VAC. In Europe, line voltages can be even higher, in some regions reaching 690 VAC.

Taking advantage of the economic benefits of a high volume product requires a power supply to be designed with the largest available input voltage range while still maintaining accurate control of the output voltages. This requirement can put heavy demands on the magnetic design (of the transformer) as well as large stresses on the semiconductor based switching devices.

In the past, reducing the voltage at the switching devices was accomplished using traditional topologies of power converters using either one or two switching devices. In particular the stacked flyback topology is one of the most cost effective solutions to provide control power from a high voltage input, particularly if multiple outputs are required. One reason is because multiple voltages may be obtained by simply adding an additional winding, diode and capacitor per output. In other topologies, like a forward converter, two diodes and an additional inductor are required, in addition to the winding and capacitor.

With reference to FIG. 1, an exemplary prior art stacked flyback converter is shown and generally indicated by the numeral 10. Capacitors C2 and C3 are identical, having the same capacitance, and are connected in series across a DC input voltage VDC. Thus, capacitors C2 and C3 form a split DC bus. A transformer T1 is constructed with two primary windings P1, P2 and one secondary winding SW. Each primary winding P1 and P2 has an associated switch S1 and S2 respectively. Switches S1 and S2 are metal—oxide—semiconductor field-effect transistors (hereinafter MOSFETs). It should be evident that, in the topology of FIG. 1, each primary winding and its associated switch only sees one half of VDC, and not the complete DC bus. The control integrated circuit directly drives switch S1 and coupling capacitor Cg drives upper switch S2. Capacitor C3 brings the source of switch S2 to the same ground potential as S1, which allows the control integrated circuit to operate S2. This is possible because, in general, capacitors pass AC voltages but block DC voltages. Thus, capacitor C3 behaves like a short circuit to any AC waveform. In operation a pulse voltage (AC voltage) is generated by the PWM control I.C. AC current flows out of the PWM control I.C, through Cg, through the gate-source junction of the power MOSFET, through C3 and back to the PWM control I.C. Capacitor Cg must have a DC voltage rating of at least VDC/2 in order to block the high voltage from the control integrated circuit. Both switches S1 and S2 operate simultaneously to apply VDC/2 to each primary P1 and P2 of T1.

As is known in the art, when switches S1 and S2 are closed current flows through primaries P1 and P2. However, because of the polarity of the primary and secondary windings of T1, the rectifier diode D1 will be reverse biased and no current will flow across C1 and R1 (the load). The current in the primary windings P1 and P2 continue to build up until a predetermined level set by the control integrated circuit. At this point, the switches S1 and S2 are simultaneously turned off in response to a signal from the control integrated circuit. At this point, the amount of electrical energy stored in the air gap of T1 has a value of E=½*L*I², where L is the primary inductance and I is the value of the peak current in the primary at the moment S1 turns off. This energy is transferred to the secondary winding. The rectifier D1 becomes forward biased and current flows into C1 and R1. This energy transfer continues until the secondary current drops to zero.

Though the traditional stacked flyback converter has proven to be a useful topology, drawbacks persist. For example, it is difficult to make a wide input range converter (e.g. 200V-1000V DC input) having enough duty cycle out of the control I.C to generate the required output voltage across the whole range. At the low end of the operating voltage range the duty cycle is limited by the control I.C and at the high end of the operating voltage range the duty cycle becomes very small (and thus the gate pulses) resulting in skipped pulses (very small pulse widths are not recognized by the MOSFET due to the input capacitance of the device). In such a situation, control can become unstable.

Thus, there exists a need in the art for an improved converter that achieves greater efficiency and control.

### SUMMARY OF THE INVENTION

According to one aspect of the present invention, a voltage converter is provided for converting a DC input voltage to a DC output voltage. The converter includes a transformer including a first primary coil, a second primary coil, and a secondary coil. A capacitor bank is electrically connected across the DC input voltage and the capacitor bank includes a first capacitor and a second capacitor. The first capacitor powers the first primary coil and the second capacitor powers the second primary coil. A first switch is associated with the first primary coil and a second switch is associated with the second primary coil. A gate drive feedback module outputs a pulse width modulated signal to drive either the first primary coil or the second primary coil. A gate drive switch has as an input the pulse width modulated signal and selectively outputs to the first switch or the second switch. A pulse steering logic module determines which of the first or the second capacitors has a higher voltage and controls the gate drive switch to direct the pulse width modulated signal to the first switch if the voltage of the first capacitor is greater than the second capacitor. If the voltage of the second capacitor is greater, the pulse steering logic module directs the pulse width modulated signal to the second switch.

According to another aspect of the present invention, a voltage converter is provided for converting a DC input voltage to a DC output voltage. The converter includes a transformer having a first primary coil, a second primary coil, and a secondary coil. A capacitor bank is electrically connected across the DC input voltage and includes a first capacitor and a second capacitor. The first capacitor powers the first primary coil and the second capacitor powers the second primary coil. A first switch is associated with the first primary coil and a second switch is associated with the second primary coil. A gate drive feedback module outputs a pulse width modulated signal to drive either the first primary coil or the second primary coil. A gate drive switch has as an input the pulse width modulated signal and selectively outputs to the first switch or the second switch. A first current sensing resistor is in series with the first primary coil and a second current sensing resistor is in series with the second primary coil. The gate drive feedback module monitors the voltage across the first current sensing resistor when the first capacitor is powering the first primary coil and the voltage across the second current sensing resistor when the second capacitor is powering the second primary coil. The gate drive feedback module regulates the pulse width modulated signal in response to the voltage across the first current sensing resistor and the second current sensing resistor.

### BRIEF DESCRIPTION OF THE DRAWINGS

The features, aspects, and advantages of the present invention will become better understood with regard to the following description, appended claims, and accompanying drawings where:

FIG. 1 is a partially schematic drawing of a prior art stacked flyback converter;

FIG. 2 is a partially schematic drawing of a stacked flyback converter according to the present invention;

FIG. 3 is a circuit drawing of a capacitor bank voltage detector circuit; and

FIG. 4 is a circuit drawing of a pulse steering circuit.

### DETAILED DESCRIPTION OF THE INVENTION

It should be noted that in the detailed description that follows, identical or similar components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

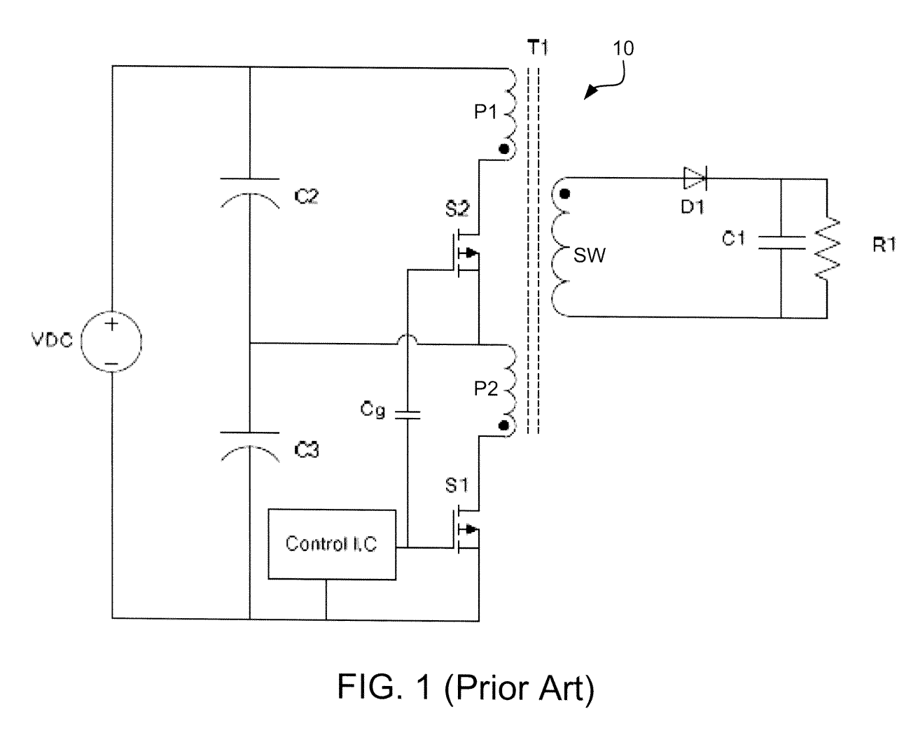

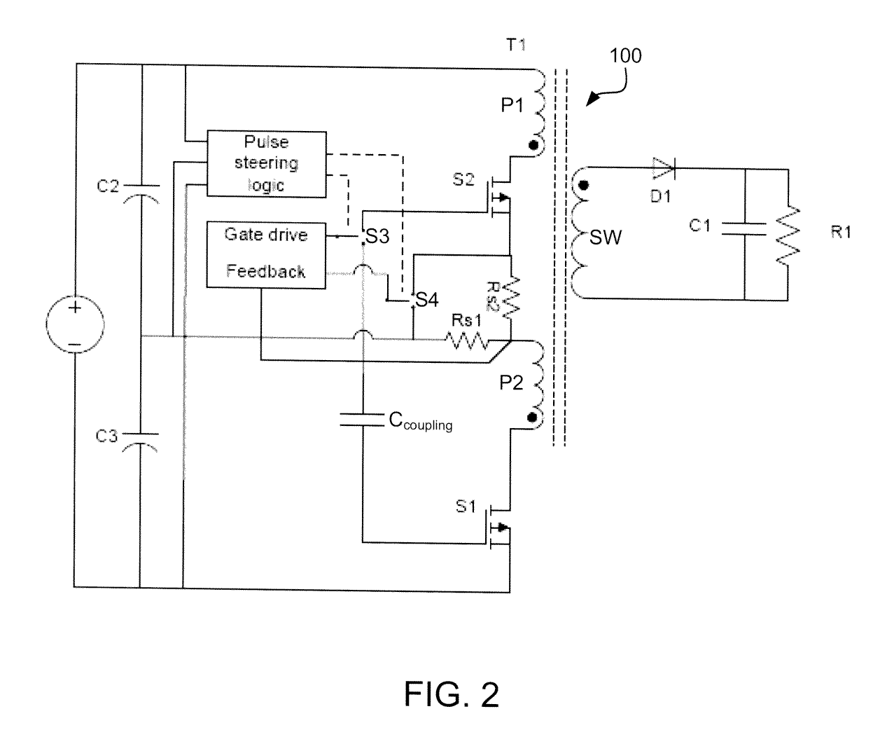

With reference now to FIG. 2, a stacked flyback converter according to the present invention is shown and generally indicated by the numeral 100. As with the configuration shown in FIG. 1, a DC power source VDC provides power to the system. It should be appreciated that, though not shown in the drawing, an AC bridge rectifier could be provided to convert an AC input voltage from a supply network to the DC input voltage to the converter. Capacitors C2 and C3 have the same rated capacitance, and are connected in series across the DC input voltage VDC. In this manner, capacitors C2 and C3 form a split DC bus. In other words, half the input voltage VDC is realized across each capacitor C2 and C3. A transformer T1 is constructed with two primary windings P1 and P2 and one secondary winding SW. Each primary winding P1 and P2 has an associated switch S1 and S2 respectively. Switches S1 and S2 are preferably MOSFETs. Each primary winding and its associated switch only sees one half of VDC, and not the complete DC bus. Thus, a lower circuit or loop is formed wherein C3 is electrically connected to Rs1 which is electrically connected to P2, which is electrically connected to switch S1 which is in turn connected to C3. Likewise, an upper circuit or loop is formed wherein C2 is electrically connected to P1 which is electrically connected to switch S2, which is electrically connected to switch Rs2, which is electrically connected to Rs1, which is in turn connected to C2.

The flyback converter 100 includes a gate drive feedback module that has two functions. First, the gate drive feedback module is a pulse width modulated gate drive that selectively drives switches S1 and S2. Pulse width modulation is a scheme where the ON time of a switch is varied in a constant frequency system. Duty cycle is defined by the ratio of on-time over total period ((tₒₙ)/(tₒₙ+t_{off})). Average voltage is directly proportional to duty cycle, thus the output voltage (couple via the transformer) can be controlled by adjusting the duty cycle. The gate drive feedback module also includes a current feedback functionality that monitors the currents flowing through the upper and lower circuits. Current feedback is required to close the control loop of the PWM controller. It tells the controller how much current is in the primary inductance of the transformer.

As will be described below in greater detail, the gate drive module drives only one switch at a time, and thus, only one primary coil is charged at a time. A gate drive switch S3 directs control signals from the gate drive feedback module to either switch S1 or S2. Switch S3 is controlled by a pulse steering logic module.

When the upper circuit is driven (i.e. switch S2 is closed and switch S1 is open), a voltage drop is measurable across resistor Rs2. Likewise, when the lower circuit is driven (i.e. switch S1 is closed and switch S2 is open), a voltage drop is measurable across resistor Rs1. These voltage drops are monitored by the gate drive feedback module according to the position of a current feedback switch S4. Current feedback switch S4 may be a single pole double throw switch having two inputs and one output, wherein only one input can be connected to the output at one time. Switch S3 and S4 are both controlled simultaneously by the pulse steering logic module so that voltage across resistor Rs2 is monitored when the top circuit is activated and voltage across resistor Rs1 is monitored when the bottom circuit is activated. These measured voltages may be precisely correlated to the actual current flowing through the respective circuit, and in the respective primary winding.

The current measurements are used by the gate drive feedback for current mode control. In current mode control, current is controlled on a cycle-by-cycle basis. Also in current mode control the inductance of the transformer primary is not as significant as it would be in voltage mode control with respect to the control scheme. In voltage mode control, the primary inductance appears as inductance and creates a double pole in the control network. In current mode control, the inductor looks more like a current source and only has one pole in the control network. The net effect is that current mode control is easier to control. The gate drive and current feedback sampling are synchronous and pulses so that pulses are not missed.

As discussed above, the pulse steering logic module is responsible for directing the gate pulses to either the high or low switch S1 or S2 as well as directing the current feedback signal from either the upper loop current sense resistor Rs2 or the lower loop current sense resistor Rs1. The pulse steering logic module monitors the voltage across both C2 and C3 and determines, based on the relative voltages, which primary coil to power. According to one embodiment of the present invention, the pulse steering logic module determines which capacitor, C2 or C3, has a higher voltage. The gate pulse switch and current sense switch is then switched to activate the circuit corresponding to the highest capacitor voltage. In this manner any imbalances in the voltages of the capacitors C2 and C3 are constantly regulated.

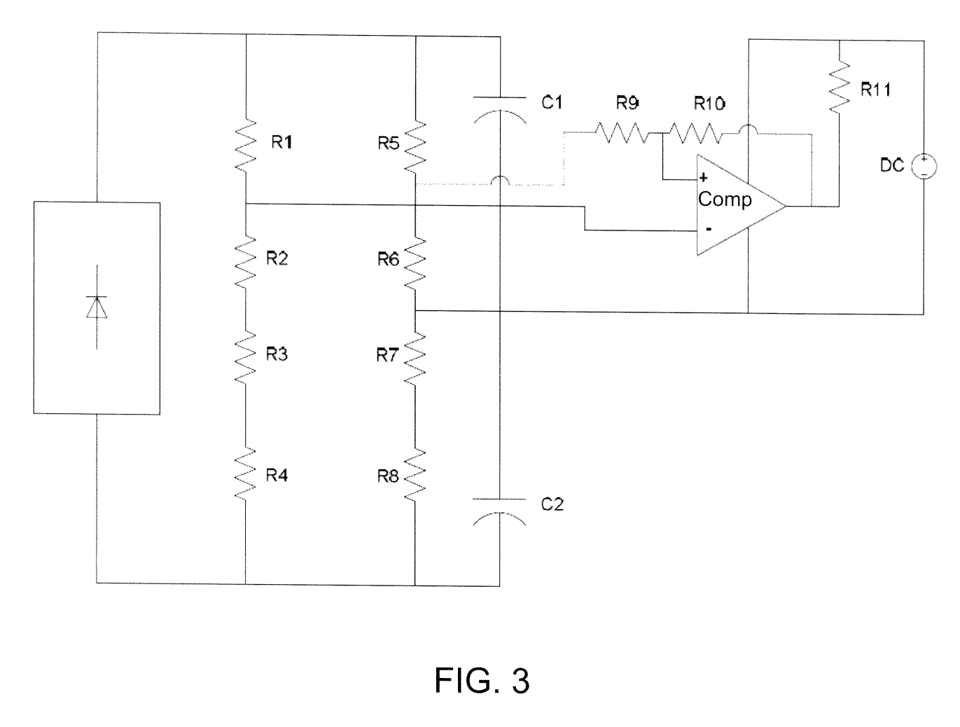

With reference to FIG. 3, a circuit is shown that provides an exemplary approach to determining the voltage imbalance present in the capacitor bank including capacitors C2 and C3. The resistors R1-R4 are connected across the DC bus. The junction of resistors R2 and R3 represent a virtual midpoint of the total DC bus, so that the voltage at this node is ½ the DC voltage. The resistors are dimensioned in such a way that the voltage at the node of R1 and R2, with respect to the node of R2 and R3 is approximately one percent of the theoretical positive half of the DC bus. For example, if the DC input voltage is 600V, the voltage at node R2-R3 is 300V and the voltage at node R1-R2 is 3V. Resistors R5-R8 are dimensioned in the same fashion except that the node of resistor R6 and R7 is connected to the neutral of the DC bus capacitor bank. The voltage at the node of resistors R5 and R6, with respect to the node of R6 and R7, represents one percent of the actual voltage across C1.

Resistors R9 and R10 set up a hysteric band around the switching point in order to eliminate multiple switching's around the reference point. When using a comparator, the hysteresis stops the comparator from oscillating when it makes a transition from low to high by creating an upper and lower limit to the reference point. Finally, resistor R11 is a pull up resistor for the comparator since the device has an open collector type output.

When in use, for example, loading on the circuit including capacitor C1 will cause the voltage across C1 to decrease. As the voltage across C2 increases, the voltage at the negative input of the comparator becomes more negative and causes the comparator to switch from low state to high state. Thus, when V_{C2}>V_{C1}=L→H. Likewise, when V_{C1}>V_{C2}=H→L. The comparison of the voltage magnitude includes the hysteresis band around the trip points. As will be seen, the output signal of the comparator is used to control the pulse steering logic.

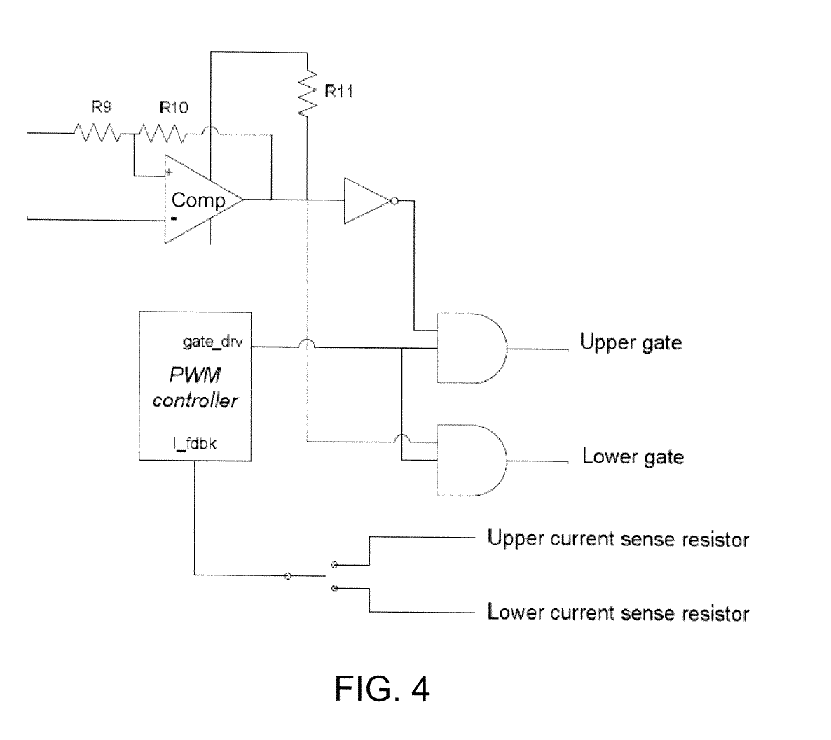

With reference to FIG. 4, a pulse steering circuit is shown. As discussed above, the comparator in the high state indicates the voltage magnitude of the lower bank (i.e. the capacitor of the lower circuit) is greater than that of the upper capacitor bank (i.e. the capacitor of the upper circuit). To correct this unbalance, primary power is taken off the lower capacitor bank in order to bring the voltage across each capacitor within limits determined by the manufacturer of the capacitor. By accessing the comparator output and its compliment signal, which is the inverse of the output, the pulse steering can be done with an AND function.

R9 and R10, as discussed above, set up the hysteresis band for the comparator. R11 is the pull up resistor for the comparator output. As is known in the art, if the input to the inverter is high, or “1”, the output will be low or “0” and vice-versa. The two AND gates function such that the output is “1” so long as both inputs are “1.” If either or both inputs are “0”, the output is “0”. As should be appreciated, the function of this circuit is to determine which switch, S1 or S2, receives the control pulse from the PWM controller. The output of the comparator also controls the current feedback switch S4 which samples the appropriate current feedback signal and routes it back to the PWM controller.

With reference again to FIG. 2, it should be appreciated that a level shift, which is a technique for transmitting a control signal to a different potential, is needed for the lower switch gate drive. As can be seen in FIG. 2, switches S1 and S2 are referenced to different DC voltages. For this reason, a coupling capacitor C_{coupling} is interposed between switch S1 and switch S3. Being a series element, it is desirable to have minimal voltage drop across C_{coupling} so that a maximum voltage is delivered to the primary switch, which is modeled as C_{gate}. It is advantageous to limit the voltage drop across the coupling capacitor to no more than 10% of the output voltage of the gate drive IC or C_{coupling}=10*Q_{gate}/V_{OH}. The coupling capacitor C_{coupling} must have the ability to provide DC blocking. In other words the DC voltage rating of the coupling capacitor C_{coupling} should be sufficiently large so that the dielectric of the capacitor is not broken by the DC voltage, of the gate drive pulses which are referenced to the upper DC capacitor bank.

While the invention has been shown and described with respect to particular embodiments thereof, those embodiments are for the purpose of illustration rather than limitation, and other variations and modifications of the specific embodiments herein described will be apparent to those skilled in the art, all within the intended spirit and scope of the invention. Accordingly, the invention is not to be limited in scope and effect to the specific embodiments herein described, nor in any other way that is inconsistent with the extent to which the progress in the art has been advanced by the invention.

We claim:

1. A voltage converter for converting a DC input voltage to a DC output voltage, the converter comprising:
a transformer including a first primary coil, a second primary coil, and a secondary coil;
a capacitor bank electrically connected across said DC input voltage, said capacitor bank including a first capacitor and a second capacitor, said first capacitor powering said first primary coil and said second capacitor powering said second primary coil;
a first switch associated with said first primary coil;
a second switch associated with said second primary coil;
a gate drive feedback module outputs a pulse width modulated signal to drive either said first primary coil or said second primary coil;
a gate drive switch having as an input said pulse width modulated signal and selectively outputting to said first switch or said second switch; and
a pulse steering logic module for determining which of said first or said second capacitors has a higher voltage and controlling said gate drive switch to direct said pulse width modulated signal to said first switch if the voltage of said first capacitor is greater than said second capacitor, and directing said pulse width modulated signal to said second switch if the voltage of said second capacitor is greater than said first capacitor.

2. The voltage converter of claim 1 further comprising a first current sensing resistor in series with said first primary coil and a second current sensing resistor in series with said second primary coil, said gate drive feedback module monitoring the voltage across said first current sensing resistor when said first capacitor is powering said first primary coil and the voltage across said second current sensing resistor when said second capacitor is powering said second primary coil.

3. The voltage converter of claim 2 wherein said gate drive feedback module regulates the pulse width modulated signal in response to said voltage across said first current sensing resistor and said second current sensing resistor.

4. A voltage converter for converting a DC input voltage to a DC output voltage, the converter comprising:
a transformer including a first primary coil, a second primary coil, and a secondary coil;
a capacitor bank electrically connected across said DC input voltage, said capacitor bank including a first capacitor and a second capacitor, said first capacitor powering said first primary coil and said second capacitor powering said second primary coil;
a first switch associated with said first primary coil;
a second switch associated with said second primary coil;
a gate drive feedback module outputs a pulse width modulated signal to drive either said first primary coil or said second primary coil;
a gate drive switch having as an input said pulse width modulated signal and selectively outputting to said first switch or said second switch; and
a first current sensing resistor in series with said first primary coil;
a second current sensing resistor in series with said second primary coil; and
wherein said gate drive feedback module monitors the voltage across said first current sensing resistor when said first capacitor is powering said first primary coil and the voltage across said second current sensing resistor when said second capacitor is powering said second primary coil, said gate drive feedback module regulating the pulse width modulated signal in response to said voltage across said first current sensing resistor and said second current sensing resistor.

5. The voltage converter of claim 4 further comprising a pulse steering logic module for determining which of said first or said second capacitors has a higher voltage and controlling said gate drive switch to direct said pulse width modulated signal to said first switch if the voltage of said first capacitor is greater than said second capacitor, and directing said pulse width modulated signal to said second switch if the voltage of said second capacitor is greater than said first capacitor.
